(19) United States
(12) Patent Application Publication
(10) Pub. No.: US 2023/0001420 A1
(43) Pub. Date: Jan. 5, 2023

(54) A FOOD WASTE PROCESSOR

(71) Applicant: EXIMO SOUTH EAST LIMITED, Hailsham, Sussex (GB)

(72) Inventors: Jerry CATHCART, Hailsham, Sussex (GB); John RUTHERFORD, Hailsham, Sussex (GB)

(73) Assignee: EXIMO SOUTH EAST LIMITED, Hailsham, Sussex (GB)

(21) Appl. No.: 17/780,468

(22) PCT Filed: Nov. 26, 2020
(86) PCT No.: PCT/EP2020/084475

§ 371 Date: May 26, 2022

(30) Foreign Application Priority Data
Nov. 27, 2019 (GB) 1917283.2

(51) Int. Cl. B02C 18/00; B02C 23/14

(52) U.S. Cl. CPC B02C 18/0084; B02C 23/14

(57) ABSTRACT

A food waste processor including a food waste inlet; a grinding station located downstream of the inlet, wherein the grinding station includes a grinding apparatus which grinds the food waste and increases pressure on the food waste; a liquid exit path from the grinding station, wherein the liquid exit path includes a filter; and a solid exit path from the grinding station, wherein a liquid component of the ground food waste is forced through the filter and exits the grinding station via the liquid exit path and a solid organic component of the ground food waste exits the grinding station via the solid exit path; the liquid exit path is in communication with a separator; the solid exit path is in communication with a compressed food waste collector; the separator separates the liquid component into water and an organic component which includes entrained food particles; the separator including a water exit path in communication with a water treatment station, and an organic component exit path in communication with an organic processing station; the organic processing station includes a storage chamber, a heater, a pump having an inlet and an outlet and an organic conduit, wherein the heater heats the storage chamber, the inlet of the pump is in communication with the storage chamber, the outlet of the pump is in communication with an inlet end of the conduit, and an outlet end of the conduit defines an organic component outlet port disposed downstream of the food waste inlet and upstream of the grinding station.

The present invention relates to food waste processors, and in particular to food waste processors which separate the food waste into a solid component, water and a grease/food particle component, wherein the solid food waste is collected, the water is filtered and cleaned before being released to a water drainage system and the grease/food particle component is recycled within the processor.

It is known to provide food waste disposal units, which typically grind or chop the food waste and pass the ground/chopped waste into a mains water drainage system. However, this causes problems for the downstream processing of the waste water and can also lead to blockages in the mains water drainage system as a result of the accumulation of fat and grease in the pipes.

It is desired to process the food waste in such a way that the component parts: solid organic mass, water and a liquid or liquified organic component are separated.

In this way, the water component may be discharged into a waste water system without the risk of blocking pipes or causing downstream problems. In addition, the solid organic mass may be used as a fuel source, for example to power a biowaste power generator.

According to a first aspect of the invention, there is provided a food waste processor including a food waste inlet; a grinding station located downstream of the inlet, wherein the grinding station includes a grinding apparatus which grinds the food waste and increases pressure on the food waste; a liquid exit path from the grinding station, wherein the liquid exit path includes a filter; and a solid exit path from the grinding station, wherein a liquid component of the ground food waste is forced through the filter and exits the grinding station via the liquid exit path and a solid organic component of the ground food waste exits the grinding station via the solid exit path; the liquid exit path is in communication with a separator; the solid exit path is in communication with a compressed food waste collector; the separator separates the liquid component into water and an organic component which includes entrained food particles; the separator including a water exit path in communication with a water treatment station, and an organic component exit path in communication with an organic processing station; the organic processing station includes a storage chamber, a heater, a pump having an inlet and an outlet and an organic conduit, wherein the heater heats the storage chamber, the inlet of the pump is in communication with the storage chamber, the outlet of the pump is in communication with an inlet end of the conduit, and an outlet end of the conduit defines an organic component outlet port disposed downstream of the food waste inlet and upstream of the grinding station.

In accordance with the invention, the food waste is ground into relatively small pieces and then pressurised. This pressurisation forces the liquid components from the food waste and leaves a relatively dry solid organic component that can be collected. The liquid components are then separated into water and a liquid organic component, which typically comprises grease and entrained food particles that are small enough to pass through the filter. The separated liquid organic components (i.e. grease and small food particles) are then maintained in a liquid state by heating them and then pumped upstream such that they are added to the food waste prior to entry into the grinding station.

It has been found that by recycling the liquid organic components in this way, the calorific value of the solid organic mass produced by the processing apparatus is increased.

Suitably, the pressurisation of the food waste within the grinding station compacts the solid organic mass in addition to forcing the liquid component from the food waste. This results in a compact output from the processor that is easier to handle, transport and store.

In an embodiment of the invention, the grinding apparatus includes a plurality of grinding wheels and/or cutting blades which reduce the size of the food waste and make it easier to process. The grinding wheels and/or cutting blades may be arranged as separate arrays of grinding wheels and or cutting blades wherein each array includes a respective rotational axis about which the grinding wheels/cutting blades rotate. In such an arrangement, the grinding wheels/blades of different arrays may overlap. For example, adjacent grinding wheels/cutting blades of a first array may define between them a gap and a grinding wheel/cutting blade of a second array may rotate within the gap.

In a further embodiment of the invention, the grinding station includes a movement apparatus which moves the food waste through the grinding station. For example, the movement apparatus may include at least one auger conveyor.

Additionally, the grinding station may further include a compression apparatus, which compresses and pressurises the food waste. Such a feature forces a portion of the liquid component from the food waste. The compression apparatus may be located downstream of the grinding apparatus, wherein the ground food waste is compressed/pressurised. In embodiments which include an auger conveyor to move the food waste through the grinding station, the pitch of the flighting of the auger conveyor decreases from a first end to a second end. This arrangement compresses the food waste as it is moved along the auger conveyor.

In a further embodiment of the invention, the grinding station is arranged vertically, wherein the inlet to the grinding station is at the top and the solid exit path is at the bottom. Such an arrangement utilises gravity to assist with the movement of the food waste through the grinding station and may reduce the energy required for moving the food waste. In such embodiments, the axis or axes about which the grinding wheels/cutting blades rotate may be arranged vertically.

In embodiments in which the grinding station is arranged vertically, the filter of the liquid exit path may surround the grinding station and the liquid exit path is radially outwards from the grinding station. In other words, the filter may be arranged as a perforated cylindrical body having a vertical axis, wherein the grinding apparatus is located within the channel defined by the cylindrical body.

The filter typically comprises a filter body which defines a plurality of apertures, wherein the average diameter of the apertures may be from 20 microns to 200 microns.

As noted above, the liquid exit path is in fluid communication with the separator which separates the liquid component into water and an organic component which includes entrained food particles that have a diameter smaller than the apertures defined by the filter. In an embodiment of the invention, the separator comprises a second filter, a removal apparatus for removing the organic component from the second filter and the organic component exit path is aligned with the removal apparatus to receive the removed organic component, wherein the apertures defined by the second filter have a smaller average diameter than the apertures of the first (grinding station) filter. In this way, the water component is able to pass through the second filter, but the organic component is retained by the filter. The removal apparatus removes the retained organic component from the filter, which is directed to the organic component exit path.

The second filter typically comprises a filter body which defines a plurality of apertures, wherein the average diameter of the apertures may be from 1 micron to 20 microns. The water passing through such a filter is sufficiently free from particulate matter that it should not cause any problems if discharged into a mains water drainage system.

The removal apparatus may be one or more blades arranged adjacent to the second filter, one or more water jets directed at the second filter, or combinations thereof. Suitably, either the filter moves in use and/or the removal apparatus moves in use, such that the removal apparatus is able to remove retained organic matter from substantially all of the second filter.

In an embodiment of the invention, the second filter is in the form of a rotatable cylinder having a substantially horizontal axis, wherein the removal apparatus acts on an upper part of the cylinder and the organic component exit path is arranged within the channel defined by the cylinder below the removal apparatus. In this embodiment, the organic matter removed from the filter by the removal apparatus falls under the action of gravity to the exit path.

The skilled person will appreciate that an amount of water is likely to be mixed with the organic matter and may be transported to the organic processing station storage chamber. In such situations, the heated organic matter, e.g. grease, will sit on top of the water in the chamber. Accordingly, the organic processing station storage chamber may include a water conduit having an inlet towards the bottom of the storage chamber and an outlet which directs the water to the water treatment station. In this way, it is just the water content that is removed from the storage chamber and directed to the water treatment station. In such embodiments, the inlet of the organic processing station pump is suitably located towards an upper portion of the storage chamber. For example, the inlet may be located in an upper half of the storage chamber.

In an embodiment of the invention, the water treatment station includes at least one UV lamp. The UV lamp(s) kill microbes, such as bacteria, algae and mould spores, that may be present in the water. The skilled person will appreciate that the water component has already been filtered, so that upon exiting the processing apparatus, it is sufficiently clean that it may safely be discharged into a mains water drainage system. Accordingly, the water treatment station may include a water outlet in fluid communication with a water drainage system.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawing in which:

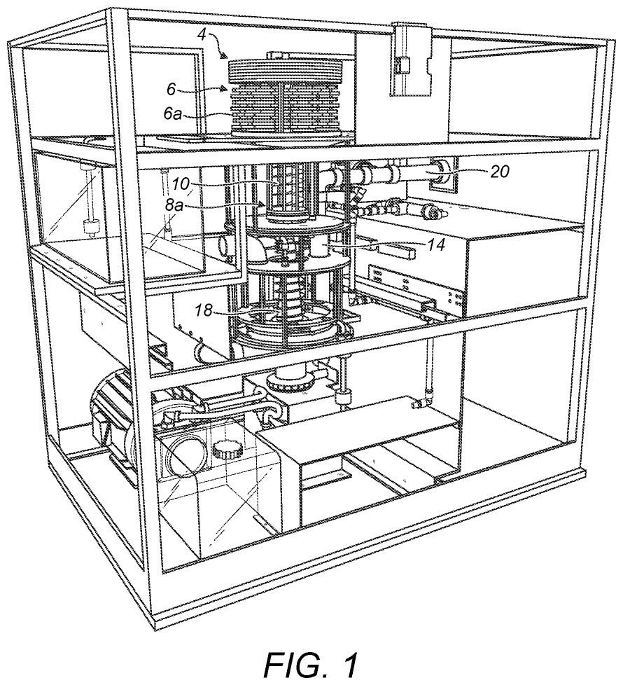

FIG. 1 shows a perspective view of a grinding station of a food waste processor according to the first aspect of the invention, with the liquid exit path filter removed for clarity;

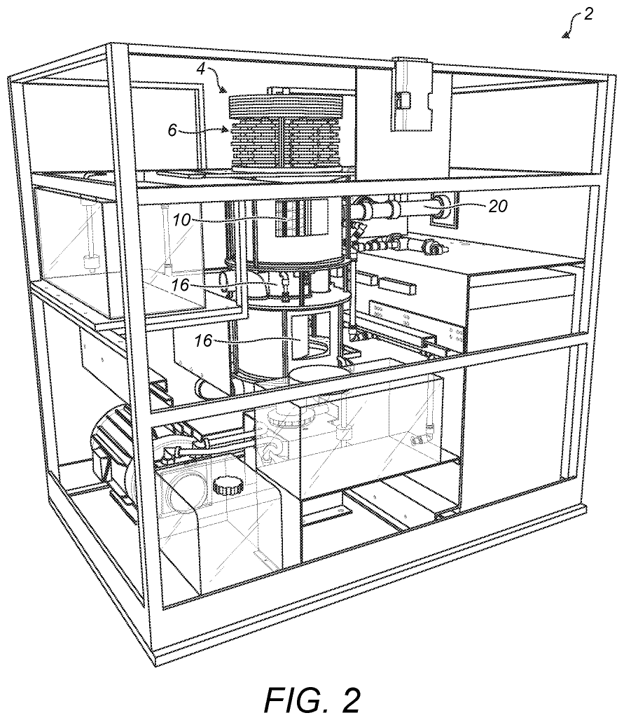

FIG. 2 shows the grinding station shown in FIG. 1 with outer covers in place;

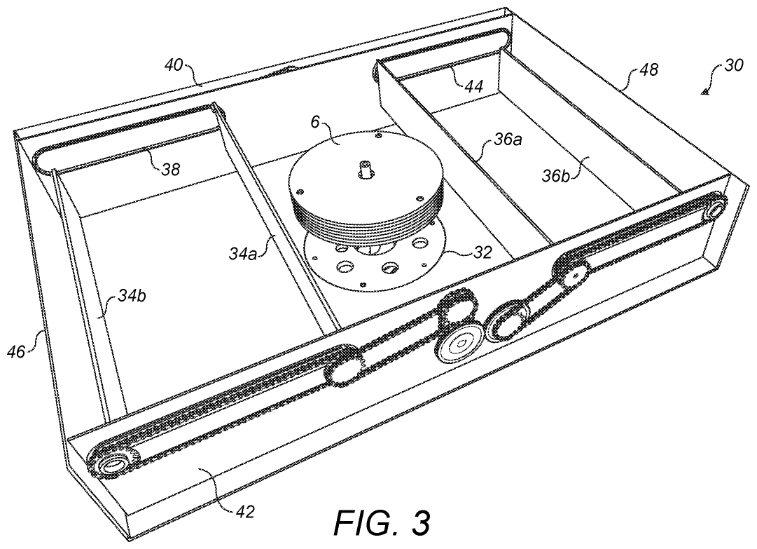

FIG. 3 shows a food waste hopper according to the first aspect of the invention;

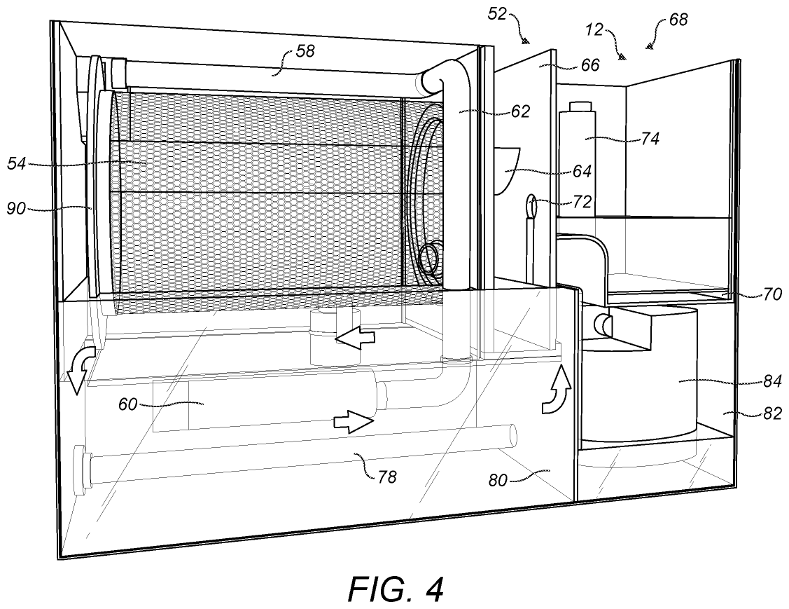

FIG. 4 shows a side view of a separator for separating water from the liquid component of the food waste; and

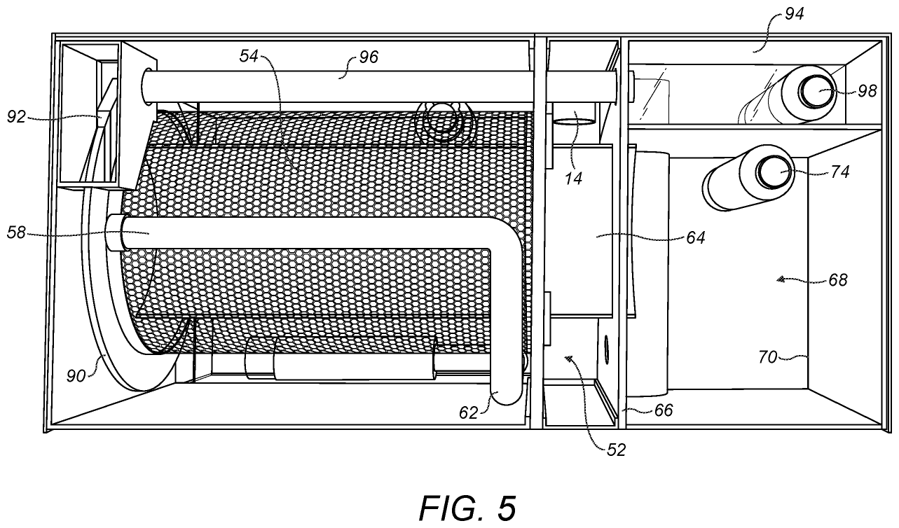

FIG. 5 shows a plan view from above of the separator shown in FIG. 4.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a grinding station 4 of a food waste processor 2. The grinding station 4 includes a cutting station 6 comprising six arrays of cutting discs 6a, wherein each array includes a central rotating shaft and a plurality of radially outwardly projecting discs 6a, wherein adjacent discs define gaps between them and discs from neighbouring arrays rotate within the gaps. Such an arrangement provides a compact and efficient cutting and grinding station.

The ground food waste is directed towards the centre of the cutting station 6, which comprises a central aperture containing an auger conveyor 10, which urges the ground food waste downwards through the aperture to a first stage compressor 8. The first stage compressor 8 includes the first auger conveyor 10 and a cylindrical mesh filter (not shown) which surrounds the auger conveyor 10. The cylindrical mesh filter defines pores therein having an average diameter of 1 mm. The pitch of the flighting of the auger conveyor 10 decreases from the top of the conveyor 10 to the bottom of the conveyor 10 such that the pressure increases within the cylindrical filter as the food waste is driven downwards by the conveyor 10. This increasing pressure within the first stage compressor 8 forces liquid components and small (i.e. less than 1 mm), entrained food particles through the cylindrical mesh filter. This liquid component is then transported to a separator 12 (shown in FIGS. 4 and 5) via a liquid conduit 14.

The solid mass not able to pass through the filter mesh is compressed and transported via the auger conveyor 10 to an outlet chute 16 (shown in FIG. 2). Within the outlet chute 16 is located a second auger conveyor 18 (shown in FIG. 1). The second auger conveyor 18 further compresses the solid mass and carries it downwards to a vacuum removal system comprising an outlet conduit 20 and a vacuum source (not shown). It will be appreciated that the solid mass produced by the processor 2 is a compressed and substantially dried solid mass.

As shown in FIG. 2, an outer cylindrical housing 22 is provided around the first stage compressor 8 and defines an annular liquid component chamber. The floor of the chamber slopes towards the liquid conduit 14 such that the liquid component exits the annular chamber into the liquid conduit 14.

FIG. 3 shows a food waste inlet comprising a hopper 30. The hopper 30 is formed as a rectangular chamber and an upper portion of the cutting station 6 extends into the hopper 30 via a central aperture 32. It will be noted that while the first auger conveyor 10 is shown in FIG. 3, the arrays of cutting discs 6a have been removed for clarity.

Food waste deposited in the hopper 30 is directed towards the cutting station 6 via two pairs of bars 34a, 34b, 36a, 36b. The first pair of bars 34a, 34b are driven to move around a track 38 defined on opposite sides 40, 42 of the hopper. The second pair of bars 36a, 36b are driven to move around a corresponding track 44 on the opposite side of the cutting station 6. The bars 34a, 34b, 36a, 36b push the food waste towards the cutting station 6 on the lower part of the track 38, 44. They then return to the outer sides 46, 48 of the hopper on the upper part of the track. A wiping action is provided for the blades 34a, 34b, 36a, 36b as they pass each other.

FIGS. 4 and 5 show the separator 12 in more detail. The liquid conduit 14 opens into a receiving chamber 52. A rotating filter drum 54 is provided in the separator which is in fluid communication at one end with the receiving chamber 52 and closed at the opposite end. The filter drum 54 defines pores having an average diameter of 10 microns. The liquid component enters the filter drum 54 via its open end. The water is able to pass through the pores and enter a water tank 56.

However, the organic matter which formed part of the liquid component carried from the first stage compressor 8 is not able to pass through the pores. The organic matter is carried by the drum 54 until it reaches an upper portion of the circle prescribed by the drum 54, at which point it is washed from the interior wall of the drum 54 by water jets defined by a manifold pipe 58. The manifold pipe 58 is fed with pressurised water from the water tank 56 by a water pump 60 and a water conduit 62. The organic matter and some of the water are washed into an arcuate collection element 64, which passes through a wall 66 of the receiving chamber 52 and into a collection tank 68.

In order to prevent the solidification of the organic matter in the collection tank 68, the tank 68 includes a heating plate 70. The heating plate 70 heats the liquid in the collection tank 68 and maintains the organic matter in a liquid state.

As the liquid organic matter floats on the water in the collection tank 68, a waste water removal conduit is provided which is open at its inlet end (not shown), located at the bottom of the tank 68, and has an outlet end 72 which empties into the receiving chamber 52.

A liquid organic matter pump 74 is provided in the collection tank 68. The pump has an inlet (not shown) located just above the water conduit outlet 72 and an outlet located at the top of the first stage compressor 8.

As noted above, by re-cycling the liquid organic matter back to the top of the first stage compressor, the calorific value of the solid organic mass, which may then be used as a fuel source, for example in the form of pellets formed from the solid organic mass.

The water in the water tank 56 that is not recycled via the water pump 60, conduit 62 and manifold pipe 58 passes over a first horizontal baffle plate 76 and into a lower portion of the tank 56, where it is irradiated with ultra violet radiation from an ultra violet light source 78. It will be appreciated that this step kills the majority of the microbes present in the water. Once irradiated with UV radiation, the water then passes over a second, vertical baffle plate 80 and into a pumping chamber 82. From the pumping chamber 82, the water is pumped into a mains water drainage system via a water pump 84.

A certain amount of oil is able to pass though the filter drum 54 and this lays on top of the water in the upper portion of the water tank 56. An oil skimmer disc 90 rotates with the drum 54 and collects the oil from the surface of the water. Oil wipers 92 then remove the oil from the skimmer disc 90 where it is transported to an oil collection chamber 94 (shown in FIG. 5) located behind the collection tank 68 via an oil conduit 96. An oil pump 98 pumps the oil to an oil storage chamber (not shown) from which it is periodically removed.

1. A food waste processor including a food waste inlet; a grinding station located downstream of the inlet, wherein the grinding station includes a grinding apparatus which grinds the food waste and increases pressure on the food waste; a liquid exit path from the grinding station, wherein the liquid exit path includes a filter; and a solid exit path from the grinding station, wherein a liquid component of the ground food waste is forced through the filter and exits the grinding station via the liquid exit path and a solid organic component of the ground food waste exits the grinding station via the solid exit path; the liquid exit path is in communication with a separator; the solid exit path is in communication with a compressed food waste collector; the separator separates the liquid component into water and an organic component which includes entrained food particles; the separator including a water exit path in communication with a water treatment station, and an organic component exit path in communication with an organic processing station; the organic processing station includes a storage chamber, a heater, a pump having an inlet and an outlet and an organic conduit, wherein the heater heats the storage chamber, the inlet of the pump is in communication with the storage chamber, the outlet of the pump is in communication with an inlet end of the conduit, and an outlet end of the conduit defines an organic component outlet port disposed downstream of the food waste inlet and upstream of the grinding station.

2. A food waste processor according to claim 1, wherein the grinding apparatus includes a plurality of grinding wheels.

3. A food waste processor according to claim 2, wherein the grinding apparatus includes a plurality of arrays of grinding wheels, wherein each array includes a respective rotational axis about which the grinding wheels rotate.

4. A food waste processor according to claim 1, wherein the grinding apparatus further includes at least one auger conveyor.

5. A food waste processor according to claim 4, wherein the pitch of the flighting of the auger conveyor decreases from a first end to a second end.

6. A food waste processor according to claim 1, wherein the grinding station is arranged vertically, wherein the inlet to the grinding station is at the top and the solid exit path is at the bottom.

7. A food waste processor according to claim 6, wherein the filter of the liquid exit path surrounds the grinding station and the liquid exit path is radially outwards from the grinding station.

8. A food waste processor according to claim 1, wherein the separator comprises a second filter, a removal apparatus for removing the organic component from the second filter and the organic component exit path is aligned with the removal apparatus to receive the removed organic component, wherein the apertures defined by the second filter have a smaller average diameter than the apertures of the first filter.

9. A food waste processor according to claim 8, wherein the removal apparatus is selected from one or more blades arranged adjacent to the second filter, one or more water jets directed at the second filter and combinations thereof

10. A food waste processor according to claim 8, wherein the second filter is in the form of a rotatable cylinder having a substantially horizontal axis, wherein the removal apparatus acts on an upper part of the cylinder and the organic component exit path is arranged within the channel defined by the cylinder below the removal apparatus.

11. A food waste processor according to claim 1, wherein the organic processing station storage chamber includes a water conduit having an inlet towards the bottom of the storage chamber and an outlet which directs the water to the water treatment station.

12. A food waste processor according to claim 1, wherein the inlet of the organic processing station pump is located towards an upper portion of the storage chamber.

13. A food waste processor according to claim 1, wherein the water treatment station includes at least one UV lamp.

14. A food waste processor according to claim 1, wherein the water treatment station includes a water outlet in fluid communication with a water drainage system.
